(19) United States
(12) Patent Application Publication
(10) Pub. No.: US 2006/0222941 A1
(43) Pub. Date: Oct. 5, 2006

(54) Non-aqueous electrolyte cell

(75) Inventors: Tetsuya Yamashita, Awaji-shi (JP); Tadashi Teranishi, Sumoto-shi (JP); Tatsuyuki Kuwahara, Kobe-shi (JP); Shoichi Inamine, Sumoto-shi (JP); Toru Amazutsumi, Sumoto-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/391,468

(22) Filed: Mar. 29, 2006

(30) Foreign Application Priority Data
Mar. 30, 2005 (JP) 2005-099348

(51) Int. Cl. H01M 2/30; H01M 2/08

(52) U.S. Cl. 429/178; 429/174; 429/181

(57) ABSTRACT

A non-aqueous electrolyte cell that is light in weight and excellent in sealing performance is provided. This object is accomplished by the following structure of a non-aqueous electrolyte cell. In the non-aqueous electrolyte cell, electric generation elements are housed in a bottomed-cylindrical outer casing can, the end portion at the opening side of the bottomed-cylindrical outer casing can is crimp-sealed via a gasket, one end of a current output terminal is connected to either one of the positive and negative electrodes, which are electric generation elements, and the other end of the current output terminal protrudes outside the cell through the opening of the bottomed-cylindrical outer casing can. The current output terminal has a flange portion and a tapering corner portion formed on the lower surface of the flange portion. Both surfaces of the flange portion are in touch with the gasket, and the crimping is made to a portion below the flange portion.

### BACKGROUND OF THE INVENTION

1) Field of the Invention

The present invention relates to an improvement of non-aqueous electrolyte cells.

2) Description of the Related Art

In recent years, there has been a rapid reduction in the size and weight of mobile information terminals such as mobile phones, notebook personal computers, and PDAs. High capacity is required of cells and batteries serving as the driving power sources of such terminals. Non-aqueous electrolyte secondary cells represented by lithium ion secondary cells have high energy density and high capacity and as such are useful as the driving power sources of the mobile information terminals.

In particular, cells in which a winding-type electrode assembly is inserted into a bottomed-cylindrical-shaped outer casing can are widely used in the above applications because such cells have a large opposing area between the positive electrode and the negative electrode, and are easy to draw a large current.

In cells that use cylindrical outer casing cans, generally, the following system (crimp-sealing system) is employed. Mechanical deformation force is applied from outside to the outer casing can to deform the end portion at the opening side of the outer casing can in a manner that enfolds a gasket made of polymer, and the gasket is compressed by the mechanical pressing force of the outer casing can. By the repulsive force as the reaction of the compression, the opening portion of the outer casing can is sealed. In this system, in order to obtain better sealing performance, groove processing is carried out such that the outer casing can is strongly compressed from outside in a manner that tightens the gasket. Since by this groove processing an inwardly protruding ring groove is formed around the outer casing can, the gasket is compressed more strongly at this portion. Thus, the sealing of the opening portion of the outer casing can is made perfect.

In order to further improve sealing performance in the above crimp-sealing system, the present inventors proposed an improved technique of the system in Japanese Patent Application Publication No. 2005-85553 (patent document 1). As shown in FIG. 4, this technique is such that by forming flange portion 4c on current collecting bar 4, the repulsive force of the gasket is prevented from being applied toward a direction not contributive to sealing. According to this technique, the gasket can be compressed sufficiently and the repulsive force is thus enhanced, thereby improving sealing performance.

### SUMMARY OF THE INVENTION

However, as a result of a further study of the technique described in Japanese Patent Application Publication No. 2005-85553, the present inventors found that there was further room for improvement of sealing performance. Specifically, the present inventors found that although forming a flange portion on the side surface of the current collecting bar improves sealing performance, mere formation of a flange portion is not sufficient. The present invention has been completed based on this finding. It is an object of the present invention to provide a non-aqueous electrolyte cell that is more excellent in sealing performance.

In order to accomplish the above and other objects, the present invention is configured as follows.

A non-aqueous electrolyte cell comprising: an electrode assembly comprising a positive electrode, a negative electrode, and a separator separating the positive and negative electrodes; a non-aqueous electrolyte; a bottomed-cylindrical outer casing can housing the electrode assembly and the non-aqueous electrolyte, an end portion at an opening side of the outer casing can being crimp-sealed via a gasket; and a current output terminal having one end thereof connected to either one of the positive and negative electrodes and the other end protrude outside the cell through an opening of the bottomed-cylindrical outer casing can, wherein: the current output terminal comprises a column portion and a flange portion protruding outward from a surface of the column portion; both upper surface and lower surface of the flange portion are in contact with the gasket; a tapering corner portion is formed on the lower surface of the flange portion where the column portion and the flange portion intersect; and the bottomed-cylindrical outer casing can is crimped at a portion of the column portion lower than the flange portion.

The technical significance of the above structure will be described. First, in the cell described in patent document 1, as shown in FIG. 4, since the repulsive force of gasket 5 is received by flange portion 4c, the adhesibility between current output terminal 4 (also referred to as a current collecting bar) and gasket 5 improves, thereby improving sealing performance. However, when forming a groove at the time of crimp-sealing, tensile force acts on the gasket in the vicinity of the lower surface of the flange portion and body portion 4b of the column portion to cause gap 7, and this undermines the adhesibility between current output terminal 4 and gasket 5.

Contrarily, in the present invention, as shown in FIG. 2, tapering corner portion 4d is provided at the portion in question so that there is no gap. With this structure, the gasket entirely adheres to the entire side surface of the current output terminal. Thus, sealing performance drastically improves.

In the above structure, the shape of the tapering corner portion may be specified as C1≧0.2L and C2≧0.2L, where C1 represents the length of the tapering corner portion, C2 represents the height thereof, and L represents the length of the flange portion.

If the length C1 and height C2 of the tapering corner portion are excessively small, the above-described effects are hard to obtain. Therefore, the length and height are preferably specified in the above manner. Also, if the length C1 of the tapering corner portion is equal to or less than the length of the flange portion and the height C2 of the tapering corner portion is equal to or less than the distance in a straight line between the lower surface of the flange portion and the lower surface of the gasket, then sufficient effects are obtained. However, if C1 and C2 are made large, the cost for processing increases, and therefore, both C1 and C2 are preferably equal to or less than 0.7L, and more preferably, equal to or less than 0.5L.

In the above structure, the bottomed-cylindrical outer casing can may be composed of aluminum or an aluminum alloy. With this structure, a reduction in the weight of the cell can be promoted.

In the above structure, the gasket may be composed of a material selected from the group consisting of tetrafluoroethylene-perfluoroalkoxyethylene copolymer, polypropylene, and ethylene-propylene-diene rubber. A material selected from the group consisting of tetrafluoroethylene-perfluoroalkoxyethylene copolymer, polypropylene, and ethylene-propylene-diene rubber is preferable because it has moderate repulsive force and is not corroded by an organic solvent.

According to the present invention with the above-described structure, no gap is caused between the gasket and the current output terminal, and the gasket entirely adheres to the side surface of the current output terminal, and therefore, a non-aqueous electrolyte cell of high preservation credibility having excellent sealing performance is provided.

### BRIEF DESCRIPTION OF THE DRAWINGS

FIG. 1(a) is an external view of a non-aqueous electrolyte cell according to example 1, and FIG. 1(b) is a partial cross sectional view of FIG. 1(a).

FIG. 2 is an enlarged cross sectional view of the sealed portion of the cell according to example 1.

FIG. 3 is an enlarged cross sectional view of the sealed portion of a cell according to example 2.

FIG. 4 is an enlarged cross sectional view of the sealed portion of a cell according to comparative example 1.

### DESCRIPTION OF REFERENCE NUMERAL

1 Positive electrode
2 Negative electrode
3 Separator
4 Negative electrode current collecting bar (current output terminal)
5 Gasket
6 Outer casing can
7 Gap

### DESCRIPTION OF THE PREFERRED EMBODIMENTS

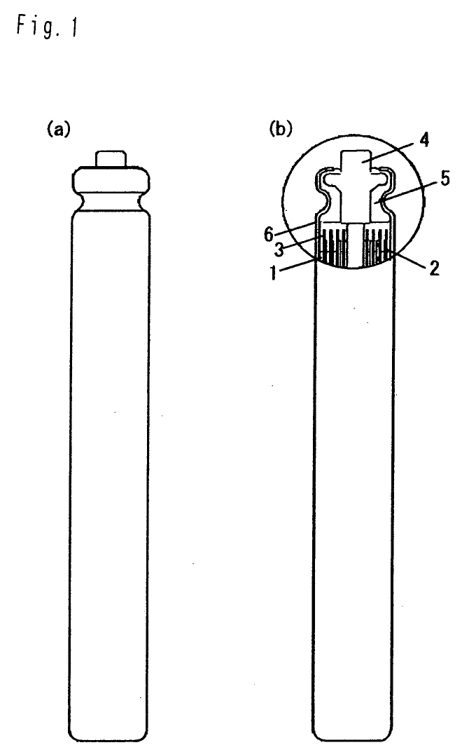

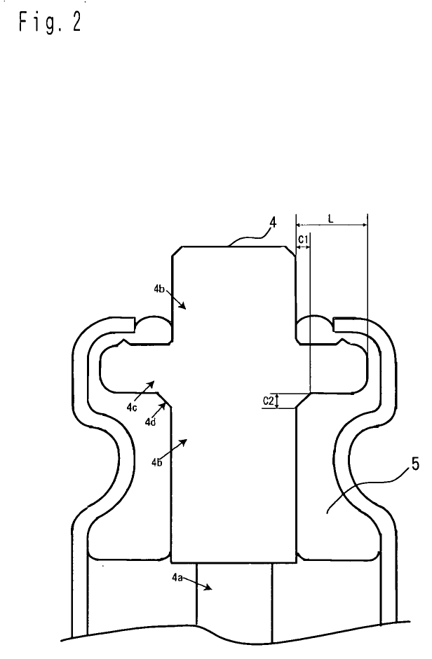

Preferred embodiments of the present invention will be described with reference to drawings. FIG. 1(a) is an external view of a non-aqueous electrolyte cell according to an embodiment of the present invention, and FIG. 1(b) is a partial cross sectional view of FIG. 1(a). FIG. 2 is an enlarged cross sectional view of the negative electrode current collecting bar. It will be appreciated that any practice of the invention with suitable amendments is possible without departing from the scope of the invention.

As shown in FIG. 1, a non-aqueous electrolyte cell of the present invention has an electrode assembly, and this electrode assembly is located in outer casing can 6. The above electrode assembly is prepared such that positive electrode 1, negative electrode 2, and separator 3 separating the electrodes are wound into a whirlpool or vortex formation. The positive electrode is electrically connected to outer casing can 6, and the negative electrode is electrically connected to negative electrode current collecting bar (current output terminal) 4 that is, as shown in FIG. 2, formed integrally with gasket 5 and has flange portion 4c. Thus, the chemical reaction energy inside the cell is drawn outside as electrical energy.

As shown in FIG. 2, the column portion of the negative electrode current collecting bar is composed of winding core 4a that also serves as the center of winding and trunk portion 4b on which the flange portion is formed and which receives the repulsive force of the gasket, and winding core 4a is made thinner than trunk portion 4b in order to wind the electrodes efficiently. The opening portion of outer casing can 6 is crimp-sealed while enfolding the gasket below flange portion 4c in order to compress the gasket from outside, and the repulsive force of the compressed gasket seals the can. On the corner of the surface on the can-bottom side of flange portion 4c, tapering corner portion 4d is formed.

(Preparation of the Positive Electrode)

Ninety two parts by weight of lithium cobalt oxide (LiCoO₂), 3 parts by weight of acetylene black as a conductive agent, 5 parts by weight of polyvinylidene fluoride (PVdF) as a binder, and N-methyl-pyrrolidone (NMP) were mixed, thus obtaining an active material slurry.

This active material slurry was uniformly applied on both surfaces of a positive electrode substrate made of an aluminum foil of 20 μm thick by doctor blade, and then dried by being passed though a heated drier, thus removing the solvent that was necessary at the time of preparing the slurry. Next, this electrode plate was compressed to a thickness of 0.17 mm by a compressing apparatus, thus preparing a positive electrode. Then, the positive electrode was cut into a width of 36 mm and a length of 70 mm, thus preparing a positive electrode plate.

(Preparation of the Negative Electrode)

Ninety eight parts by weight of a negative electrode active material made of graphite, 1 part by weight of a binder made of styrene butadiene rubber (SBR), 1 part by weight of a thickening agent made of carboxy methyl cellulose (CMC), and water were mixed, thus obtaining an active material slurry. This active material slurry was uniformly applied on both surfaces of a copper foil (15 μm thick) as a negative electrode substrate by doctor blade, and then dried by being passed though a heated drier, thus removing the solvent that was necessary at the time of preparing the slurry. Next, this electrode plate was compressed to a thickness of 0.15 mm by a compressing apparatus, thus preparing a negative electrode. Then, the negative electrode was cut into a width of 40 mm and a length of 75 mm, thus preparing a negative electrode plate.

(Preparation of the Electrolytic Solution)

In a mixture solvent in which ethylene carbonate (EC) and dimethyl carbonate (DMC) were mixed at a mass ratio of 3:7, LiPF₆ as electrolytic salt was dissolved at 1 M (mole/liter), thus preparing an electrolytic solution.

(Preparation of the Separator)

A microporous film (0.025 mm thick) of polyethylene was cut into a width of 44 mm and a length of 170 mm, and dried, thus preparing a separator.

(Preparation of Electrode Assembly)

As shown in FIG. 2, to the negative electrode plate prepared in the above manner was mounted negative electrode current collecting bar 4 of stainless steel which had: a column portion composed of cylindrical winding core 4a and trunk portion 4b; flange portion 4c having a circular cross section; tapering corner portion 4d formed on the lower surface of flange portion 4c; and gasket 5 of tetrafluoroethylene-perfluoroalkoxyethylene copolymer that was insert-molded. Then, positive electrode plate 1 and negative electrode plate 2 were superposed with separator 3 in between in such a manner that the center lines in the width direction of the electrodes would agree. Then, using a winding apparatus, winding was carried out with negative electrode current collecting bar 4, which also served as the winding core, being the center of winding, and the outermost periphery was taped, thus preparing a wound electrode assembly.

It should be noted that the length L of the flange portion was 1.5 mm, and the length C1 of the tapering corner portion and the height C2 of the tapering corner portion were both 0.3 mm. The cross section of the tapering corner portion was straight-line shaped. As shown in FIG. 2, current collecting bar 4 was such that in order to increase volume energy density, the diameter of winding core 4a was formed smaller than the diameter of trunk portion 4b.

After drying this electrode assembly 1, 500 mg of an electrolytic solution was injected into outer casing can 6 of 0.30 mm thick made of aluminum, and then, the electrode assembly was inserted. Then, by carrying out crimp-sealing while enfolding polymer gasket 5, a non-aqueous electrolyte secondary cell according to example 1 such that the entire height was 55 mm, the diameter was 6 mm, and the theoretical capacity was 120 mAh was prepared.

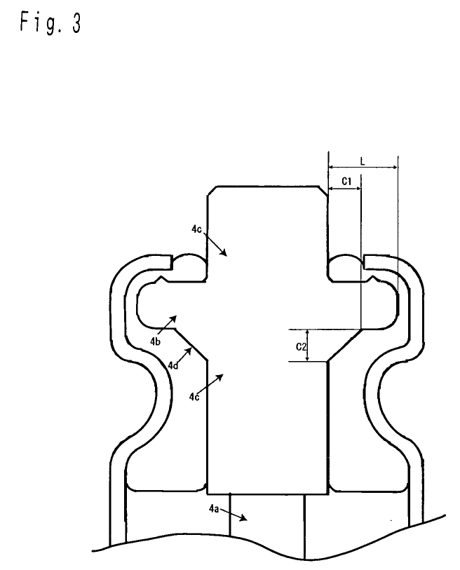

As shown in FIG. 3, a non-aqueous electrolyte secondary cell according to example 2 was prepared in the same manner as example 1 except that the length L of the flange portion was 1.5 mm, and the length C1 of the tapering corner portion and the height C2 of the tapering corner portion were both 0.7 mm.

### Comparative Example 1

A non-aqueous electrolyte secondary cell according to comparative example 1 was prepared in the same manner as example 1 except that the length L of the flange portion was 1.5 mm, and the tapering corner portion was not formed.

(Heat Shock Test)

The above cells were charged at a constant current of 1 I t (120 mA) to 4.2 V, and then charged at a constant voltage of 4.2 V to 0.02 I t (2.4 mA). The cells were then subjected to 120 and 240 heat shock cycles in which the cells were preserved at 70° C. for 30 minutes and then at −30° C. for 30 minutes. The number of samples of each cell was 10. The mass of each sample was measured before and after the test, and the number of samples that reduced their mass after the test was counted. The results are listed in Table 1 below.

TABLE 1

| | | The number of | The number of |
|---|---|---|---|
| | | samples of mass | samples of mass |
| | Tapering | reduction after | reduction after |
| | corner portion | 120 cycles | 240 cycles |
| Example 1 | 0.3 mm | 0 | 0 |
| Example 2 | 0.7 mm | 0 | 0 |
| Comparative | Not formed | 2 | 3 |
| Example 1 | | | |

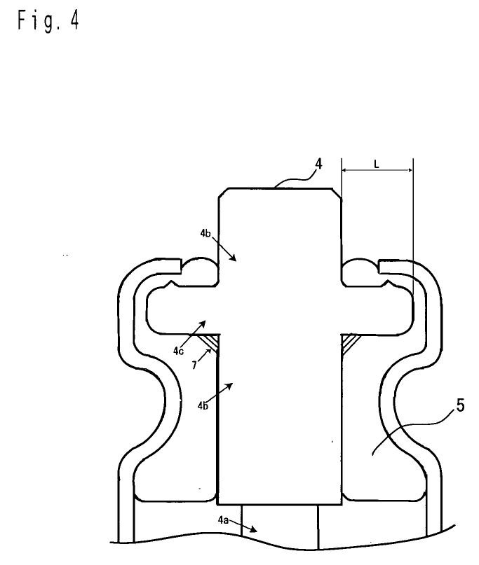

From Table 1 above, in the cells that used a negative electrode current collecting bar having tapering corner portion 4d on the lower surface of flange portion 4c, there was no mass reduction after 240 heat shock cycles. On the other hand, as shown in FIG. 4, in the cell that used a negative electrode current collecting bar not having the tapering corner portion provided on the lower surface of flange portion 4c, there was mass reduction in two of the ten samples after 120 heat shock cycles, and in three of the ten samples after 240 heat shock cycles.

This can be considered as follows. As shown in FIG. 4, if the tapering corner portion is not formed on the lower surface of the flange portion, because of groove-forming at the time of crimp-sealing, tensile force acts on gasket 5, thereby causing gap 7 between gasket 5 and flange portion 4c. Thus, sealing performance decreases. Therefore, through heat shock cycles, sealability decreases because the repulsive force is taken away, thereby causing leakage of the electrolytic solution. Thus, mass reduction occurs.

On the other hand, as shown in FIGS. 2 and 3, if tapering corner portion 4d is formed on the lower surface of flange portion 4c, this tapering corner portion fills the gap. Thus, a cell in which there is no leakage of the electrolytic solution and which is excellent in sealing performance is obtained.

(Supplementary Remarks)

As the outer casing material of the non-aqueous electrolyte secondary cell according to the present invention, for a reduction in the weight of the cell, aluminum or an aluminum alloy is preferably used.

As the gasket material, such polymer is preferably used that has moderate repulsive force and is not corroded by an organic solvent. As such a material, tetrafluoroethylene-perfluoroalkoxyethylene copolymer (PFA), polypropylene (PP), and ethylene-propylene-diene rubber (EPDM) can be exemplified.

While in the above examples the length C1 of the tapering corner portion and the height C2 of the tapering corner portion are the same, they may not be the same. In addition, the cross section of the tapering corner portion may not be straight-line shaped as shown in FIG. 2.

The diameters of the winding core and trunk portion of the negative electrode current collecting bar may be the same.

By employing these structures, a non-aqueous electrolyte cell that is further more light in weight and further more excellent in sealing performance can be provided.

What is claimed is:

1. A non-aqueous electrolyte cell comprising:
an electrode assembly comprising a positive electrode, a negative electrode, and a separator separating the positive and negative electrodes;
a non-aqueous electrolyte;
a bottomed-cylindrical outer casing can housing the electrode assembly and the non-aqueous electrolyte, an end portion at an opening side of the outer casing can being crimp-sealed via a gasket; and
a current output terminal having one end thereof connected to either one of the positive and negative electrodes and the other end protrude outside the cell through an opening of the bottomed-cylindrical outer casing can, wherein:
the current output terminal comprises a column portion and a flange portion protruding outward from a surface of the column portion;
both upper surface and lower surface of the flange portion are in contact with the gasket;
a tapering corner portion is formed on the lower surface of the flange portion where the column portion and the flange portion intersect; and
the bottomed-cylindrical outer casing can is crimped at a portion of the column portion lower than the flange portion.

2. The non-aqueous electrolyte cell according to claim 1, wherein shape of the tapering corner portion is specified as C1≧0.2L and C2≧0.2L, where C1 represents length of the tapering corner portion, C2 represents height thereof, and L represents length of the flange portion.

3. The non-aqueous electrolyte cell according to claim 1, wherein shape of the tapering corner portion is specified as 0.7L≧C1≧0.2L and 0.7L≧C2≧0.2L, where C1 represents length of the tapering corner portion, C2 represents height thereof, and L represents length of the flange portion.

4. The non-aqueous electrolyte cell according to claim 2, wherein the bottomed-cylindrical outer casing can is composed of aluminum or an aluminum alloy.

5. The non-aqueous electrolyte cell according to claim 2, wherein the gasket is composed of a material selected from the group consisting of tetrafluoroethylene-perfluoroalkoxyethylene copolymer, polypropylene, and ethylene-propylene-diene rubber.
